(19) United States
(12) Patent Application Publication
(10) Pub. No.: US 2009/0006522 A1
(43) Pub. Date: Jan. 1, 2009

(54) INTEGRATED INTERFACE APPARATUS AND METHOD FOR HETEROGENEOUS SENSOR NETWORKS

(75) Inventors: Mal-Hee KIM, Daejon (KR); Kyoung-Woo LEE, Seoul (KR); Hye-Eun KWON, Seoul (KR); Joo-Sang PARK, Daejon (KR); Yong-Joon LEE, Daejon (KR); Jong-Hyun PARK, Daejon (KR); Jong-Suk CHAE, Daejon (KR)

Correspondence Address: CANTOR COLBURN, LLP, 20 Church Street, 22nd Floor, Hartford, CT, 06103, US

(73) Assignees: Electronics and Telecommunications Research Institute, Daejon (KR); Galim Information Technology, Seoul (KR)

(21) Appl. No.: 12/145,947

(22) Filed: Jun. 25, 2008

(30) Foreign Application Priority Data
Jun. 26, 2007 (KR) 10-2007-0063040

(51) Int. Cl. G06F 15/16

(52) U.S. Cl. 709/201

(57) ABSTRACT

Provided are an integrated interface apparatus and a method for heterogeneous sensor networks. The integrated interface apparatus includes an application system interface for converting a query command of an application system into a sensor network command according to a common message protocol, analyzing a response message with respect to the sensor network command, and transmits the converted command to the application system; and a sensor network interface for converting the sensor network command according to characteristics of the corresponding sensor network, transmitting the converted sensor network command to the corresponding sensor network, converting sensing data of the respective sensor networks according to predefined data format, and transmitting the converted sensing data to the application system interface over the response message with respect to the sensor network command.

### CROSS-REFERENCE TO RELATED APPLICATIONS

The present invention claims priority of Korean Patent Application No. 10-2007-0063040, filed on Jun. 26, 2007, which is incorporated herein by reference.

### BACKGROUND OF THE INVENTION

1. Field of the Invention

The present invention relates to an integrated interface apparatus and method for heterogeneous sensor networks; and, more particularly, to an integrated interface apparatus and method for heterogeneous sensor networks, which are capable of providing an integrated interface to allow the access to the heterogeneous sensor networks, whereby the application system can easily access the heterogeneous sensor networks. Accordingly, the development of various application services will be promoted and the utilization of the sensor network infrastructure can be improved.

This work was supported by the Information Technology (IT) research and development program of the Korean Ministry of Information and Communication (MIC) and the Korean Institute for Information Technology Advancement (IITA) [2006-S-022-01, “Sensor Network Abstraction Technique over USN infrastructure”].

2. Description of Related Art

In the current sensor network application technologies, the sensor network application systems and the sensor networks have been developed in 1:1 correspondence by establishing the sensor networks specified to the sensor network application systems, that is, the application services.

FIG. 1 illustrates the architecture of a conventional sensor network service framework using an application/sensor network adaptor.

Referring to FIG. 1, the conventional service framework includes a sensor network application system 11, an application/sensor network dependent adaptor 12, and an application-specific sensor network 13.

The sensor network application system 11 transmits a query to the application/sensor network dependent adaptor 12 so as to receive sensing data from the sensor network 13.

The application/sensor network dependent adaptor 12 transmits the query received from the sensor network application system 11 according to the characteristics of the corresponding sensor networks, and transmits the converted query to the sensor network 13. Thereafter, the application/sensor network dependent adaptor 12 transmits the sensing data measured or sensed at the sensor network 13 or specific event results to the sensor network application system 11.

The sensor network 13 includes sensors or actuators required by the corresponding application services, and transmits the sensing data to the application/sensor network dependent adaptor 12 according to the received query. The sensor/sensor network dependent adaptor 12 functions to support interfaces of the query of the sensing data, the sensing data report, and the specific event generation.

However, the interface function of the application/sensor network dependent adaptor 12 is defined such that the dependent relation is made only between the sensor network application system 11 and the corresponding sensor network 13. That is, the application/sensor network dependent adaptor 12 functions to simply connect the sensor network 13 and the sensor network application system 11. The sensor network application system 11 must be connected to other application/sensor network dependent adaptor 12 whenever it wants to be connected to other sensor network.

In the inside and outside of the country, a variety of studies have been conducted on a middleware that can process various queries by using various sensor networks as a conceptual database. However, these studies have not dealt with various attributes of heterogeneous sensor networks. Till now, several application services, e.g., sea pasturage or u-healthcare, have been verified by using various sensor network infrastructures. However, the application systems for various application services cannot share the various heterogeneous sensor networks. In particular, when a plurality of heterogeneous sensor networks using different sensor types or communication protocols are distributed over wide service area, the application systems cannot access the different sensor networks.

That is, in the conventional service framework, the various application systems cannot share the various heterogeneous sensor networks. Hence, when the application system accesses a plurality of heterogeneous sensor networks, the access is possible only through the sensor network adaptors. Consequently, it is difficult to develop various application services.

Furthermore, since the application systems cannot share the heterogeneous sensor networks, the sensor network infrastructure available in each sensor network application system cannot be operated efficiently, leading to increase in installation or management cost of USN infrastructure.

### SUMMARY OF THE INVENTION

An embodiment of the present invention is directed to providing an integrated interface apparatus and method for heterogeneous sensor networks, which are capable of providing an integrated interface to allow the access to the heterogeneous sensor networks, whereby the application system can easily access the heterogeneous sensor networks. Accordingly, the development of various application services will be promoted and the utilization of the sensor network infrastructure can be improved

In accordance with an aspect of the present invention, there is provided an integrated interface apparatus for heterogeneous sensor networks, including: an application system interface for converting a query command of an application system into a sensor network command according to a common message protocol, analyzing a response message with respect to the sensor network command, and transmits the converted command to the application system; and a sensor network interface for converting the sensor network command according to characteristics of the corresponding sensor network, transmitting the converted sensor network command to the corresponding sensor network, converting sensing data of the respective sensor networks according to predefined data format, and transmitting the converted sensing data to the application system interface over the response message with respect to the sensor network command.

In accordance with another aspect of the present invention, there is provided an integrated interface method for heterogeneous sensor networks, including: converting a query command of an application system into a sensor network command, based on a common message protocol; converting the sensor network command according to characteristics of a corresponding sensor network, and transmitting the converted sensor network command to the corresponding sensor network; converting sensing data of sensor networks into a predefined data format; and analyzing the converted sensing data according to the query command, and transmitting the analysis result to the application system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 illustrates the architecture of a conventional sensor network service framework using an application/sensor network adaptor.

FIG. 2 illustrates the architecture of a sensor network service framework in accordance with an embodiment of the present invention.

FIG. 3 illustrates the architecture of the integrated interface apparatus of FIG. 2 in accordance with an embodiment of the present invention.

FIG. 4 is a flowchart illustrating a network connection method in the integrated interface operation for the heterogeneous sensor networks in accordance with an embodiment of the present invention.

FIG. 5 illustrates a process of converting the sensing data, based on the value/type definition table of the sensing data.

FIG. 6 is a flowchart illustrating an automatic sensor network monitoring method of the network interface unit 222 in accordance with an embodiment of the present invention.

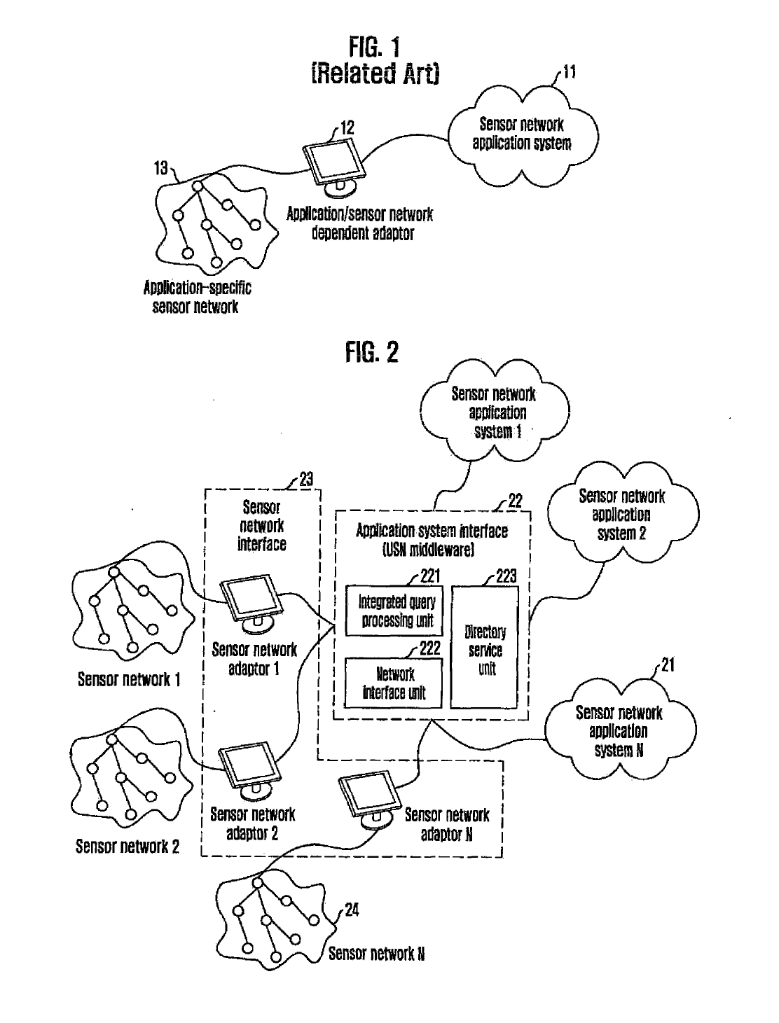

### DESCRIPTION OF SPECIFIC EMBODIMENTS

The advantages, features and aspects of the invention will become apparent from the following description of the embodiments with reference to the accompanying drawings, which is set forth hereinafter.

FIG. 2 illustrates the architecture of a sensor network service framework in accordance with an embodiment of the present invention.

Referring to FIG. 2, an integrated interface apparatus for heterogeneous sensor networks in accordance with an embodiment of the present invention includes an application system interface 22 serving as a ubiquitous sensor network (USN) middleware, and a sensor network interface 23 serving as a sensor network adaptor. The application system interface 22 includes an integrate query processing unit 221, a network interface unit 222, and a directory service unit 223.

A plurality of sensor network application systems and a plurality of sensor networks in relation to a sensor network service framework will be described below. The sensor network application systems 21 use a plurality of heterogeneous sensor networks to provide a variety of application services, for example, water supply and drainage management, medical service, or building management.

The sensor networks 24 include sensors and actuators, which support a variety of sensing types. The sensors and actuators of the sensor networks 24 operate according to query commands of the sensor network application systems 21.

The application system interface 22 converts the integrated queries of the sensor network application systems 21 into sensor network commands based on a standardized interface, that is, a common message protocol, and transmits the converted commands to the sensor network interface 23. The application system interface 22 receives sensing data from the sensor network interface 23 and transmits the received sensing data to the sensor network application systems 21 according to the sensor network commands.

That is, the application system interface 22 supports the integrated interface between the sensor network application systems 21 and the sensor network interface 23. The application system interface 22 requests, collects or processes the sensing data required by the sensor network application systems 21, and transmits the sensing data to the sensor network applications 21.

The sensor network interface 23 provides the integrated interface between the heterogeneous sensor networks 24 and the application system interface 22. The sensor network interface 23 converts the sensor network commands received from the application system interface 22 into characteristic information about the corresponding sensor networks, for example, information about sensors, actuators, communication protocols, and buffering parameters of the sensor networks.

In the application system interface 22, the directory service unit 223 stores the sensor network metadata for access and management of the sensor networks 24. The sensor networks 24 are connected to the application system interface 22 through the sensor network interface 23. The directory service unit 223 can provide the stored sensor network metadata according to a request of the integrated query processing unit 221, the network interface unit 222, or the sensor network interface 23.

The integrated query processing unit 221 schedules the integrated queries of the sensor network application systems 21 the respective sensor network. The integrated query processing unit 221 transmits the integrated queries to the network interface unit 222 according to the scheduling. The integrated query processing unit 221 collects the sensing data required by the sensor network application systems 21, and transmits the collected sensing data to the sensor network application systems 21. The integrated query processing unit 221 processes the sensing data according to the purposes of the application services required by the sensor network application systems 21, and transmits the processed sensing data to the sensor network application systems 21.

The network interface unit 222 converts the integrated queries into the sensor network commands based on the standardized interface, that is, the common message protocol, according to the scheduling of the integrated query processing unit 221, and transmits the converted integrated queries to the sensor network interface 23. In other words, the network interface unit 222 defines the common message protocol and provides a sensor network abstraction through the integrated interface with respect to the sensor networks 24. Thereafter, the network interface 222 receives the sensing data from the sensor network interface 23 according to the sensor network commands and transmits the received sensing data to the integrated query processing unit 221.

The application system interface 22 includes a variety of components, in addition to the integrated query processing unit 221, the network interface unit 222, and the directory service unit 223. For example, the application system interface 22 may include components for a sensor data mining unit (not shown) for extracting high level of data desired by the user from the collected sensing data, a situation information processing unit (not shown) for acquiring information on given situations and processing the acquired situation information, or an event processing unit (not shown) for processing a variety of events required by the sensor network application systems.

The sensor network application systems 21 can collect information through the sensor networks suitable for the purposes of the sensor networks 21 connected to the application system interface 22 performing the USN middleware function, and drive the actuators of the sensor networks.

A plurality of heterogeneous sensor networks are connected to the application system interface 22 through the sensor network adaptor 23 that transparently connects the sensor network characteristic information to the network interface unit 222. The sensor network characteristic information includes information about sensors, actuators, communication protocols, buffering parameters of the respective sensor networks.

In this embodiment of the present invention, the common message protocol between the application interface 22 and the sensor network interface unit 23 is defined so that the sensor network application systems 21 can access the various sensor networks 21 in an abstracted form. The sensor networks 21 is connected to the application system interface 22 through the sensor network interface 23 so that it can be connected based on the defined common message protocol and perform operations such as the sensor query and report and monitoring.

A following Table 1 shows the standardized integrated interface, that is, the common message protocol between the sensor network interface 23 and the network interface unit 222 of the application system interface 22. The network interface unit 222 performs the request, the processing, and the continuous monitoring of the sensing data by using a variety of common messages defied in Table 1 below.

TABLE 1

| Group | Type | Name | Flow |
|---|---|---|---|
| Request/ | Node list metadata | NodeListMetaReq | → |
| Response | request | | |
| | Node List metadata | NodeListMetaRes | ← |
| | response | | |
| | Buffer data request | BufferDataReq | → |
| | Buffer data response | BufferDataRes | ← |
| | Command control | CmdActionReq | → |
| | request | | |
| | Command control | CmdActionRes | ← |
| | result | | |
| Command/ | Command for instant | InstantCmd | → |
| Report | sensing | | |
| | Conditional command | InstantWithCondCmd | → |
| | for instant sensing | | |
| | Command for periodic | ContinuousCmd | → |
| | sensing | | |
| | Conditional command | ContinuousWithCondCmd | → |
| | for periodic sensing | | |
| | Actuator operation | RunActuatorCmd | → |
| | command | | |
| | Monitoring command | StatusCheckCmd | → |
| | Report of sensing | SensingValueRpt | ← |
| | value | | |
| | Report of finish of | FinishRpt | ← |
| | sensing command | | |
| | Report of actuator | RunActuatorRpt | ← |
| | operation result | | |
| | Report of error | ErrorRpt | ← |
| | Report of sensor | SNUpdateRpt | ← |
| | network update | | |
| | Report of monitoring | StatusCheckRpt | ← |
| Connection | Connection | ConnReqCtrl | ←* |
| control | confirmation request | | |
| | Disconnection | DisConnReqCtrl | ←→ |
| | request | | |
| | Connection | ConnInfoCtrl | → |
| | information response | | |
| | Channel check | ChannelCheckCtrl | ←→ |
| | request | | |
| | Channel confirmation | ChannelConfirmCtrl | ←→ |
| | response | | |
| Message | Error check | NakChk | ←→ |
| check | notification | | |

The common message protocol between the application system interface 22 and the sensor network interface 23 will be described with reference to Table 1. The common message protocol is divided into a request/response group, a command/report group, a connection control group, and a message check group. Detailed types of commands in the respective groups are shown in Table 1. For example, the request/response group includes a node list metadata request command, a node list metadata response command, a buffer data request command, a buffer data response command, a command control request command, and a command control result command. The names of the respective commands are defined and transfer flow of these commands are shown in Table 1. For example, “→” represents the request command sent from the application system interface 22 to the sensor network interface 23, and “←” represents the request command sent from the sensor network interface 23 to the application system interface 22.

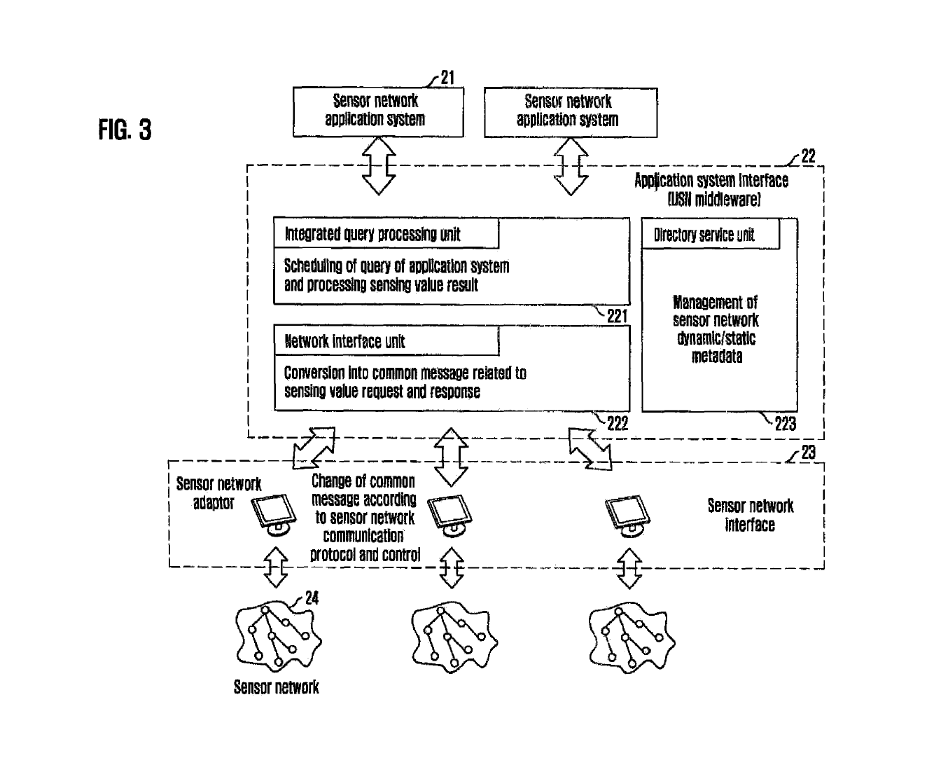

FIG. 3 illustrates the architecture of the integrated interface apparatus of FIG. 2 in accordance with an embodiment of the present invention.

The sensor network application system 21 transmits the integrated query to the application system interface 22 so as to receive the sensing data from the sensor of the sensor network 24.

The integrated query processing unit 221 schedules the queries about the sensor networks, which are transmitted from the sensor network application systems 21. The integrated query processing unit 221 generates the queries suitable for the sensor network metadata of the sensor networks, and transmits the generated queries to the network interface unit 222.

The network interface unit 222 converts the queries about the sensor networks into sensing data request commands, and transmits the sensing data request commands to the sensor network interface 23. The network interface unit 222 converts the command into the sensing data request command by referencing the sensor network metadata stored in the directory service unit 223.

The sensor network interface unit 23 converts the sensing data request command from the network interface unit 222 into commands suitable for the characteristic information of the sensor networks, and transmits the converted commands to the sensor networks 24. The characteristic information of the sensor networks includes information about sensors, actuators, communication protocols, and buffering parameters.

Thereafter, the sensor network interface 23 receives the sensing data from the sensor networks 24 according to the sensing data request command, converts the received sensing data according to the sensor network metadata, and transmits the converted sensing data to the network interface unit 222.

The sensing data converted based on the common message protocol are transmitted to the sensor network application system 21 through the integrated query processing unit 221. Through these conversion processes, the sensor network application system 21 requests the sensing data to the sensor networks 24 by using the common message, regardless of the characteristics of the sensor networks 24, and receives the sensing data converted based on the common message protocol.

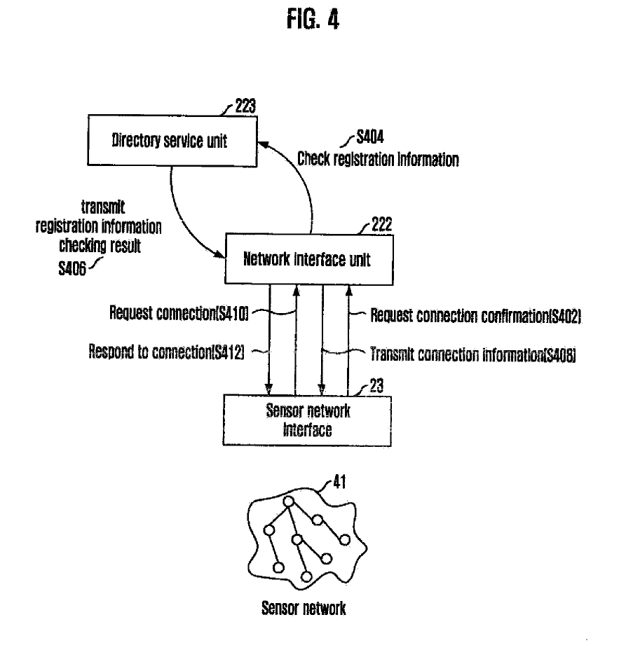

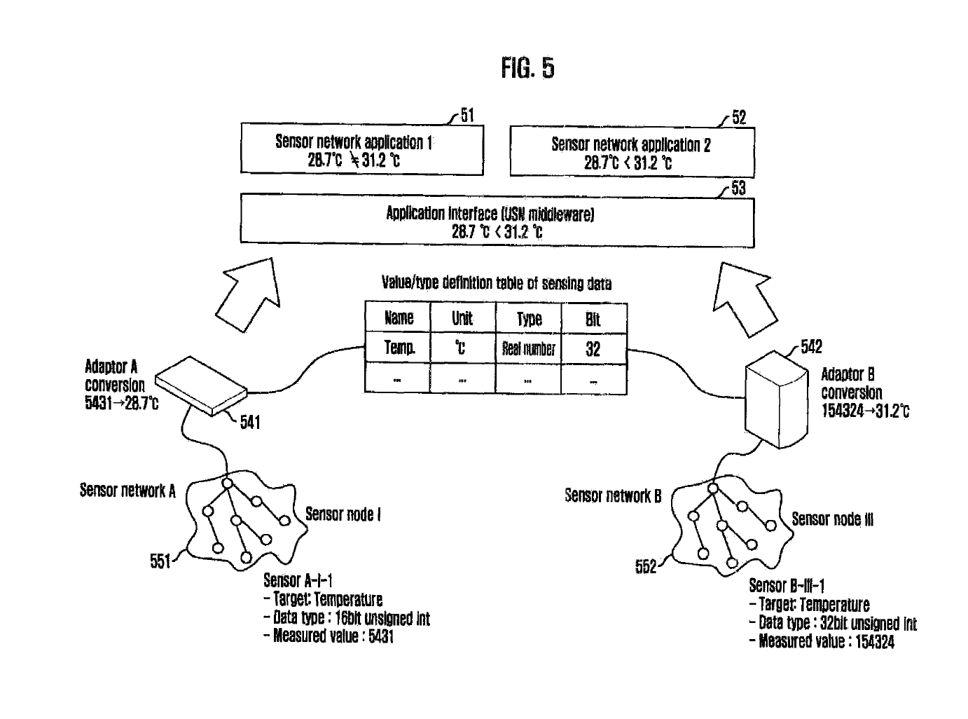

FIG. 4 is a flowchart illustrating a network connection method in the integrated interface operation for the heterogeneous sensor networks in accordance with an embodiment of the present invention.

In operation S402, the sensor network interface 23 requests the connection check to the network interface unit 222 by using the connection confirmation command (ConnReqCtrl) defined in the common message protocol.

In operation S404, the network interface unit 222 requests the registration information check to the directory service unit 223 according to the connection confirmation request. In operation S406, the directory service unit 223 checks the registration information and transmits the registration information checking result to the network interface unit 222.

In operation S408, the network interface unit 222 checks the registration through the registration information checking result transmitted from the directory service unit 223.

In operation S410, the sensor network interface 23 checks the possibility of the connection by using the received connection information and requests the connection to the network interface unit 222 by using the connection information.

In operation S412, the network interface unit 222 connects the network in response to the connection request of the sensor network interface unit 23.

Consequently, the network interface unit 222 requests the directory service unit 223 to determine if the sensor network is a previously registered sensor network, and permits the connection. At this point, the network interface unit 222 denies the connection of the sensor networks that request the connection to the interface defined in the common message protocol. The network interface unit 222 can provide the reliable sensing data to the sensor network application system by performing an authentication to determine if the sensor network is the registered sensor network. This sensor network authentication can be performed in two ways.

First, the operator of the application system interface 22 previously registers in the directory service unit 223 the registration information of the sensor network 41, whose function is checked. When the connection request of the sensor network interface 23 is received, the directory service unit 223 checks whether the requested sensor network is registered or not by using the registration information of the previously registered sensor networks, and notifies the checking result to the network interface unit 222. The network interface unit 222 checks the connection of the directory service unit 223 and permits the network connection. That is, as illustrated in FIG. 4, the directory service unit 223 performs the authentication of the sensor network 41.

Second, the sensor network 41 requests the connection to the network interface unit 222 through the sensor network interface 23. At this point, the network interface unit 222 reads the registration information of the sensor network 41 from the directory service unit 223 according to the connection request, performs the authentication of the sensor network 41, and permits the connection.

The network authentication methods can be performed in various ways.

A first network authentication method is to check only the allocated sensor network identifiers. This method has disadvantages in that the appropriation of the network identifier is easy and it is vulnerable to the network security.

A second network authentication method is to use a password for an allocated sensor network identifier. The password is transmitted together when the sensor network identifier is allocated.

A third network authentication method is to use a public key authentication. When using the public key, overhead may occur because an encryption module is implemented on an adaptor of the sensor network interface 23.

FIG. 5 illustrates a process of converting the sensing data, based on the value/type definition table of the sensing data.

A following Table 2 shows an example of the value/type definition table of the sensing data. The sensor network interface converts the sensing data according to the data standard formats, e.g., representation unit, type, and byte, with respect to the data types, e.g., ID and name, defined in Table 2 below.

TABLE 2

| | | Presentation | | | |
|---|---|---|---|---|---|
| ID | Name | type | Type | Byte | Remarks |
| 0x1701 | Temperature | ° C. | Real number | 4 | |
| 0x1702 | Salt | % | Real number | 4 | |
| 0x1703 | Dissolved | % | Real number | 4 | |
| | oxygen | | | | |
| 0x1704 | Remaining | V | Real number | 4 | |
| 0x1705 | power | % | Integer | 2 | |
| 0x1706 | Pulse | bpm | Integer | 4 | Beat |
| | | | | | Per |
| | | | | | Minute |
| 0x1707 | Momentum | Step count | Integer | 4 | Step |
| | | | | | count |
| 0x1708 | Location | Location ID | Character | 15 | |
| | | | string | | |
| 0x1709 | Pressure | gf/cm² | Integer | 2 | |
| 0x170A | Height | Cm | Integer | 2 | |
| 0x170B | Gas | Ppm | Integer | 2 | |
| | concentration | | | | |
| 0x170C | Illuminance | Lux | Integer | 2 | |
| 0x170D | MIC | DB | Integer | 2 | |
| 0x170E | Humidity | % | Real number | 4 | |
| 0x170F | Pressure | mmH2O | Integer | 2 | |

For example, when the directory service unit 223 includes an adaptor A 541 and an adaptor B 542, the sensor network adaptor A 541 converts the type of the sensing data acquired through the sensor node of the sensor network A 551, based on the type definition table of the sensing data defined in Table 2, and the sensor network adaptor B 542 converts the type of the sensing data acquired through the sensor node of the sensor network B 552, based on the type definition table of the sensing data defined in Table 2.

The data type and method of the sensing data are changed even at the same temperature according to the type of the sensor included in the sensor network A 551 or the sensor network B 552. In the case of the sensor node A-I-1 of the sensor network A 551, the sensing target is temperature and the data type is 16-bit unsigned integer. The measured value is 5431. At this point, the sensor network adaptor A 541 converts the measured value of 5431 into 28.7° C., based on the value/type definition table of the sensing data.

In addition, in the case of the sensor node B-III-3 of the sensor network B 552, the sensing target is temperature and the data type is 32-bit unsigned integer. The measured value is 154324. At this point, the sensor network adaptor B 542 converts the measured value of 154324 into 31.2° C., based on the value/type definition table of the sensing data.

The application system interface 53 transmits the sensing data (28.7° C. and 31.2° C.) received from the sensor network A 541 and the sensor network B 542 to the sensor network application system 1 51 or the sensor network application system 2 52. At this point, the application system interface 53 can transmit the comparison result of 28.7° C. and 31.2° C. to the sensor network application system 1 51 or the sensor network application system 2 52 according to the corresponding query.

The sensor network adaptors connected to the sensor networks convert the different sensor network characteristics into defined standard types by using the sensor network metadata of Table 2, and transmit them to the USN middleware by using the common message protocol of Table 1. Through these processes, the sensor network abstraction is provided.

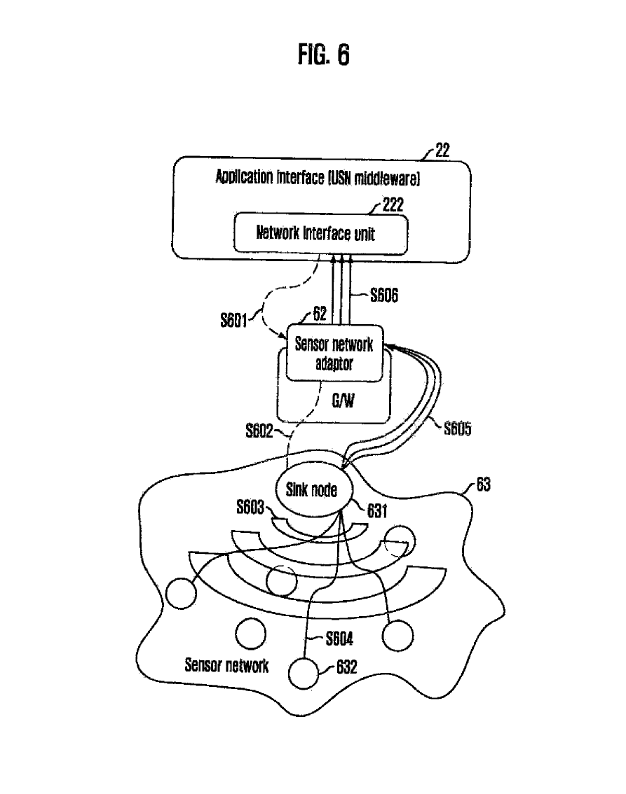

FIG. 6 is a flowchart illustrating an automatic sensor network monitoring method of the network interface unit 222 in accordance with an embodiment of the present invention.

The network interface unit 222 of the application system interface 22 transmits the monitoring command (StatusCheckCmd), which is defined in Table 1, through the sensor network adaptor 62 at predetermined periods. Then, the network interface unit 222 analyzes the monitoring report (StatusCheckRpt) received as the response of the monitoring command, and determines the sensor nodes receiving no monitoring report (StatusCheckRpt) during a predetermined time as the abnormal operation. That is, when no monitoring report (StatusCheckRpt) does not arrive from the sensor network 63, the network interface unit 222 determines the sensor network 63 as the abnormal operation. The monitoring report message with respect to the monitoring report StatusCheckRpt includes a remaining power of each sensor node, a sensor node error, and current topology information of the sensor network. The network interface unit 222 can know if the sensor node is added to or removed from the sensor network by using the sensor network update report described in Table 1.

The monitoring processing operation will be described with reference to FIG. 6.

In operation S601, the network interface unit 222 transmits the monitoring command (StatusCheckCmd) to the sensor network adaptor 62 according to the period defined for each sensor network. The period defined for each sensor network is managed as static sensor network metadata. The sensor network metadata are stored in the directory service unit 223.

In operation S602, the sensor network adaptor 62 converts the received monitoring command (StatusCheckCmd) into a status report request applicable to the sensor network 63, and transmits the status report request to the sensor network.

In operation S603, a sink node 631 of the sensor network 63 transmits the status report request to the sensor node 632 of the sensor network 63.

In operation S604, the sensor node 632 receiving the status report request transmits the topology related information to the sink node 631. The topology related information includes remaining power information, error information, and parent node information. In operation S604, the sink node 631 transmits the topology related information to the sensor network to the sensor network adaptor 62.

In operation S606, the sensor network adaptor 62 collects the status information received from each sensor node, and transmits the collected status information to the network interface unit 222 through the monitoring report (StatusCheckRpt). The update information about the sensor network metadata is transmitted to the directory service unit 223, so that the directory service unit 223 can retain the latest sensor network condition information.

In accordance with the embodiments of the present invention, the integrated interface between the application system and the heterogeneous sensor networks is standardized according to the predefined common message protocol regardless of the characteristic information of the heterogeneous sensor network. Therefore, the application system can access the heterogeneous sensor networks through the integrated interface, regardless of the sensor network characteristics.

That is, the details of the sensor networks are standardized or abstracted through the common message protocol. Therefore, only if the adaptor is implemented, the sensor networks can be connected to the application system interface, the USN middleware, to serve as the USN infrastructure function. In addition, various application service can be developed through the abstracted various sensor network infrastructure. In other words, heterogeneous sensor networks are abstracted with respect to the upper USN middleware components and applications. Therefore, when the sensor network is connected to satisfy only the integrated interface, the sensor networks can be applied safely and stably at a low development cost.

Furthermore, the present invention is not the simple connection between the sensor network and the USN middleware, but provides the authentication function so that the reliable sensor network information can be provided by using the authentication function 223. Consequently, the stability of the USN infrastructure can be provided.

Moreover, by automatically monitoring the sensor networks in real time, the situation information of the current sensor network is provided to other components or applications. Therefore, the sensor networks can be used without error, and the error of the sensor networks can be automatically recovered.

The above described method according to the present invention can be embodied as a program and be stored on a computer readable recording medium. The computer readable recording medium is any data storage device that can store data which can be read by the computer system. The computer readable recording medium includes a read-only memory (ROM), a random-access memory (RAM), a CD-ROM, a floppy disk, a hard disk and an optical magnetic disk.

While the present invention has been described with respect to the specific embodiments, it will be apparent to those skilled in the art that various changes and modifications may be made without departing from the spirit and scope of the invention as defined in the following claims.

What is claimed is:

1. An integrated interface apparatus for heterogeneous sensor networks, comprising:
an application system interface means for converting a query command of an application system into a sensor network command according to a common message protocol, analyzing a response message with respect to the sensor network command, and transmits the converted command to the application system; and
a sensor network interface means for converting the sensor network command according to characteristics of the corresponding sensor network, transmitting the converted sensor network command to the corresponding sensor network, converting sensing data of the respective sensor networks according to predefined data format, and transmitting the converted sensing data to the application system interface means over the response message with respect to the sensor network command.

2. The integrated interface apparatus of claim 1, wherein the application system interface means includes:
a directory service means for storing the common message protocol and characteristic information of the sensor networks for access and management of the respective sensor networks;
an integrated query processing unit for scheduling the query command of the application system according to the sensor networks, and transmitting the sensing data extracted from the network interface means to the application system; and
the network interface means for converting the scheduled query command into the sensor network command according to the common message protocol, analyzing the response message with respect to the sensor network command, and extracting the sensing data.

3. The integrated interface apparatus of claim 2, wherein the common message protocol comprises a common message protocol about sensing data request and response, operation command of the sensor node, access and connection of the sensor networks, and monitoring of the sensor networks.

4. The integrated interface apparatus of claim 2, wherein the network interface means periodically transmits a monitoring command message to the sensor networks through the sensor network interface means, analyzes a monitoring report message collected at the sensor network interface means, and periodically monitors the sensor networks.

5. The integrated interface apparatus of claim 4, wherein the monitoring report message comprises status information about the sensor nodes of the sensor networks and topology information of the sensor networks.

6. The integrated interface apparatus of claim 5, wherein the directory service unit updates the topology information by using the analysis result of the monitoring report message.

7. The integrated interface apparatus of claim 6, wherein the directory service unit previously registers the characteristic information of the sensor networks, which is received from a user, and authenticates the sensor networks according to an authentication request of the network interface means by using the previously registered characteristic information.

8. The integrated interface apparatus of claim 6, wherein the network interface means authenticates the sensor networks according to an authentication request of the sensor networks by using the characteristic information of the sensor networks stored in the directory service means.

9. An integrated interface method for heterogeneous sensor networks, comprising:
converting a query command of an application system into a sensor network command, based on a common message protocol;
converting the sensor network command according to characteristics of a corresponding sensor network, and transmitting the converted sensor network command to the corresponding sensor network;
converting sensing data of sensor networks into a predefined data format; and
analyzing the converted sensing data according to the query command, and transmitting the analysis result to the application system.

10. The integrated interface method of claim 9, wherein the common message protocol comprises a common message protocol about sensing data request and response, operation command of the sensor node, access and connection of the sensor networks, and monitoring of the sensor networks.

11. The integrated interface method of claim 9, wherein the transmitting of the converted sensor network command comprises:
periodically transmitting a monitoring command message to the sensor networks through the sensor network interface means;
analyzing a monitoring report message collected at the sensor network interface means; and
periodically monitors the sensor networks.

12. The integrated interface method of claim 11, wherein the monitoring report message comprises status information about the sensor nodes of the sensor networks and topology information of the sensor networks.

13. The integrated interface method of claim 12, wherein the transmitting of the converted sensor network command comprises:
previously registering the characteristic information of the sensor networks, which is received from a user; and
authenticating the sensor networks according to an authentication request of the network interface means by using the previously registered characteristic information.
